(19) United States
(12) Patent Application Publication
(10) Pub. No.: US 2024/0097850 A1
(43) Pub. Date: Mar. 21, 2024

(54) TRANSMISSION CONFIGURATION INDICATOR INDICATION FOR NON-SERVING CELL INFORMATION

(71) Applicant: QUALCOMM INCORPORATED, San Diego, CA (US)

(72) Inventors: Yan ZHOU, San Diego, CA (US); Fang YUAN, Beijing (CN); Tao LUO, San Diego, CA (US)

(21) Appl. No.: 18/257,079

(22) PCT Filed: Dec. 8, 2021
(86) PCT No.: PCT/CN2021/136281

§ 371 Date: Jun. 12, 2023

(30) Foreign Application Priority Data
Feb. 5, 2021 (WO) PCTCN2021075508

(51) Int. Cl. H04L 5/00; H04W 72/20

(52) U.S. Cl. CPC H04L 5/0051; H04L 5/0091; H04W 72/20

(57) ABSTRACT

Various aspects of the present disclosure generally relate to wireless communication. In some aspects, a user equipment (UE) receives an indication to use a transmission configuration indicator (TCI) state for receiving or transmitting a communication, the TCI state indicating non-serving cell information associated with a non-serving cell. The UE receives or transmits the communication based at least in part on the TCI state and a quasi co-location (QCL) chain rule applied for the TCI state that indicates the non-serving cell information. The QCL chain rule may indicate that a synchronization signal block (SSB) of the non-serving cell as a source reference signal provides QCL information for one or more signals of a first cell and that the one or more signals of the first cell as source reference signals provide QCL information for one or more channels or signals of a second cell. Numerous other aspects are provided.

### CROSS-REFERENCE TO RELATED APPLICATION

This patent application claims priority to Patent Cooperation Treaty (PCT) Patent Application No. PCT/CN2021/075508, filed on Feb. 5, 2021, entitled “TRANSMISSION CONFIGURATION INDICATOR INDICATION FOR NON-SERVING CELL INFORMATION,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses for transmission configuration indicator (TCI) indication for non-serving cell information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

To support inter-cell multi-transmit receive point (TRP), a reference signal from a non-serving cell of a UE can be indicated in a transmission configuration indicator (TCI) state to be used by the UE in association with transmitting or receiving a communication. For example, the TCI state may provide quasi co-location (QCL) information indicating a QCL relationship between a source reference signal associated with the non-serving cell and a target reference signal or channel of the serving cell of the UE or the non-serving cell of the UE. The source reference signal associated with the non-serving cell may be, for example, a synchronization signal block (SSB) associated with the non-serving cell. In an inter-cell multi-TRP scenario, the TCI state may indicate other information related to the non-serving cell (herein referred to as non-serving cell information). This non-serving cell information may include, for example, a cell identifier of the non-serving cell (for example, a physical cell identifier (PCI)) or information associated with an SSB of the non-serving cell (for example, an SSB time domain position, an SSB transmission periodicity, or an SSB transmission power), among other examples. In practice, the UE is configured with (at least) the cell identifier of the non-serving cell and the information associated with the SSB of the non-serving cell to enable inter-cell multi-TRP operation.

### SUMMARY

In some aspects, a method of wireless communication performed by a user equipment (UE) includes receiving an indication to use a transmission configuration indicator (TCI) state for receiving or transmitting a communication, where the TCI state indicates non-serving cell information associated with a non-serving cell of the UE. In some aspects, the method includes receiving or transmitting the communication based at least in part on the TCI state and a quasi co-location (QCL) chain rule applied for the TCI state that indicates the non-serving cell information. In some aspects, the QCL chain rule indicates that a synchronization signal block (SSB) of the non-serving cell as a source reference signal provides QCL information for one or more signals of a first cell and that the one or more signals of the first cell provide QCL information for one or more channels or signals of a second cell.

In some aspects, a UE for wireless communication includes at least one processor, and at least one memory communicatively coupled with the at least one processor and storing processor-readable code that, when executed by the at least one processor, is configured to cause the UE to receive an indication to use a TCI state for receiving or transmitting a communication, where the TCI state indicates non-serving cell information associated with a non-serving cell of the UE. In some aspects, the processor-readable code, when executed by the at least one processor, is configured to cause the UE to receive or transmit the communication based at least in part on the TCI state and a QCL chain rule applied for the TCI state that indicates the non-serving cell information. In some aspects, the QCL chain rule indicates that an SSB of the non-serving cell as a source reference signal provides QCL information for one or more signals of a first cell and that the one or more signals of the first cell provide QCL information for one or more channels or signals of a second cell.

In some aspects, a non-transitory computer-readable medium storing a set of instructions for wireless communication includes one or more instructions that, when executed by one or more processors of a UE, cause the UE to receive an indication to use a TCI state for receiving or transmitting a communication, where the TCI state indicates non-serving cell information associated with a non-serving cell of the UE. In some aspects, the instructions cause the UE to receive or transmit the communication based at least in part on the TCI state and a QCL chain rule applied for the TCI state that indicates the non-serving cell information. In some aspects, the QCL chain rule indicates that an SSB of the non-serving cell as a source reference signal provides QCL information for one or more signals of a first cell and that the one or more signals of the first cell as source reference signals provide QCL information for one or more channels or signals of a second cell.

In some aspects, an apparatus for wireless communication includes means for receiving an indication to use a TCI state for receiving or transmitting a communication, where the TCI state indicates non-serving cell information associated with a non-serving cell of the apparatus. In some aspects, the apparatus includes means for receiving or transmitting the communication based at least in part on the TCI state and a QCL chain rule applied for the TCI state that indicates the non-serving cell information. In some aspects, the QCL chain rule indicates that an SSB of the non-serving cell as a source reference signal provides QCL information for one or more signals of a first cell and that the one or more signals of the first cll as source reference signals provide QCL information for one or more channels or signals of a second cell.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station (BS) in communication with a user equipment (UE) in a wireless network in accordance with the present disclosure.

FIG. 3 illustrates an example logical architecture of a distributed radio access network (RAN), in accordance with the present disclosure.

FIG. 4 is a diagram illustrating an example of inter-cell multi-downlink control information (DCI) based multi-transmit receive point (TRP) operation in accordance with the present disclosure.

FIG. 5 is a diagram illustrating an example associated with a transmission configuration indicator (TCI) indication for non-serving cell information in accordance with the present disclosure.

FIG. 6 is a flowchart illustrating an example process performed, for example, by a UE in accordance with the present disclosure.

FIG. 7 is a block diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to a quasi co-location (QCL) chain rule to be applied when a transmission configuration indicator (TCI) indication indicates information associated with a non-serving cell. Some aspects more specifically relate to a QCL chain rule to be applied when a TCI state that indicates non-serving cell information is indicated to a user equipment (UE) for use in association with transmitting or receiving a communication (for example, a communication with a serving cell of the UE, a communication with the non-serving cell of the UE). In some aspects, the QCL chain rule may be utilized by a UE configured for inter-cell multi-downlink control information (DCI) multi-TRP operation.

A TCI state defines a QCL relationship between a source reference signal and a target reference signal. In some aspects, the QCL chain rule defines QCL relationships among a group of signals or channels. For example, the QCL chain rule may define that a synchronization signal block (SSB) of the non-serving cell, as a source reference signal of a TCI state, provides QCL information for one or more signals of a first cell, the first cell being the serving cell or the non-serving cell. In some aspects, the QCL chain rule further indicates that the one or more signals of the first cell, as source reference signals of TCI states, provide QCL information for one or more channels or signals of a second cell, the second cell being the serving cell or the non-serving cell. That is, the QCL chain rule may indicate a QCL relationship between an SSB of the non-serving cell and one or more signals of the first cell, and may further indicate a QCL relationship between the one or more signals of the first cell and one or more channels or signals of the second cell. In some aspects, the UE implements the QCL chain rule to determine a configuration for a beam to be used in association with transmitting or receiving a communication. That is, the UE may utilize the QCL chain rule to determine a beam indication according to the QCL relationships associated with the QCL chain rule, and may transmit or receive a communication accordingly.

In some aspects, a TCI state may be at least one of the following types: (1) a joint downlink (DL)/uplink (UL) common TCI state that may be used (for example, by a base station) to indicate a common beam for at least one DL channel or reference signal and at least one UL channel or reference signal (for example, a Type 1 TCI state); (2) a separate DL common TCI state that may be used to indicate a common beam for at least two DL channels or reference signals (for example, a Type 2 TCI state); (3) a separate UL common TCI state that may be used to indicate a common beam for at least two UL channels or reference signals (for example, a Type 3 TCI state); (4) a separate DL single channel or reference signal TCI state that may be used to indicate a beam for a single DL channel or reference signal (for example, a Type 4 TCI state); or (5) a separate UL single channel or reference signal TCI state that may be used to indicate a beam for a single UL channel or reference signal (for example, a Type 5 TCI state). In some aspects, a TCI state may be a unified TCI state. A unified TCI state may indicate information associated with QCL relationships among a group of signals or channels across multiple component carriers. In some scenarios, a unified TCI state indication may enable improved or optimized use of TCI state indications (for example, by reducing a number of TCI state indications that need to be communicated), for updating a parameter associated with reference signal used in association with defining a QCL relationship, or for UL/DL beam indication, among other examples. Depending on the type of TCI state, the TCI state may provide QCL information as beam information for DL channels or reference signals and/or may provide spatial transmit filter information as beam information for UL channels or reference signals.

Particular aspects of the subject matter described in this disclosure can be implemented to realize one or more of the following potential advantages. In some examples, the described techniques can enable inter-cell multi-TRP operation using a TCI state that indicates non-serving cell information without significantly increasing complexity of the UE. As an example, the described techniques can enable a UE to utilize non-serving cell information, indicated in a TCI state signaled to the UE, to determine a configuration for a beam to be used in association with transmitting or receiving a communication during inter-cell multi-TRP operation in a simplified manner (for example, based on the non-serving cell information and the QCL rule) and without a need for explicit configuration of the beam, thereby reducing complexity of inter-cell multi-TRP operation at the UE. Additionally, in some examples, the described techniques can be used to enable a beam of the non-serving cell to be used for transmitting or receiving a communication during inter-cell multi-TRP operation, thereby improving reliability of communications during inter-cell multi-TRP operation. As an example, the described techniques can enable a UE to determine, based on the non-serving cell information and the QCL rule, a configuration for a beam of the non-serving cell to enable the beam of the non-serving cell to be used in association with transmitting or receiving a communication, meaning that reliability of communications during inter-cell multi-TRP operation can be improved (for example, by enabling the beam of the non-serving cell to be used for the communication). As a result, some aspects of the subject matter described in this disclosure may have a positive impact on network performance or device performance.

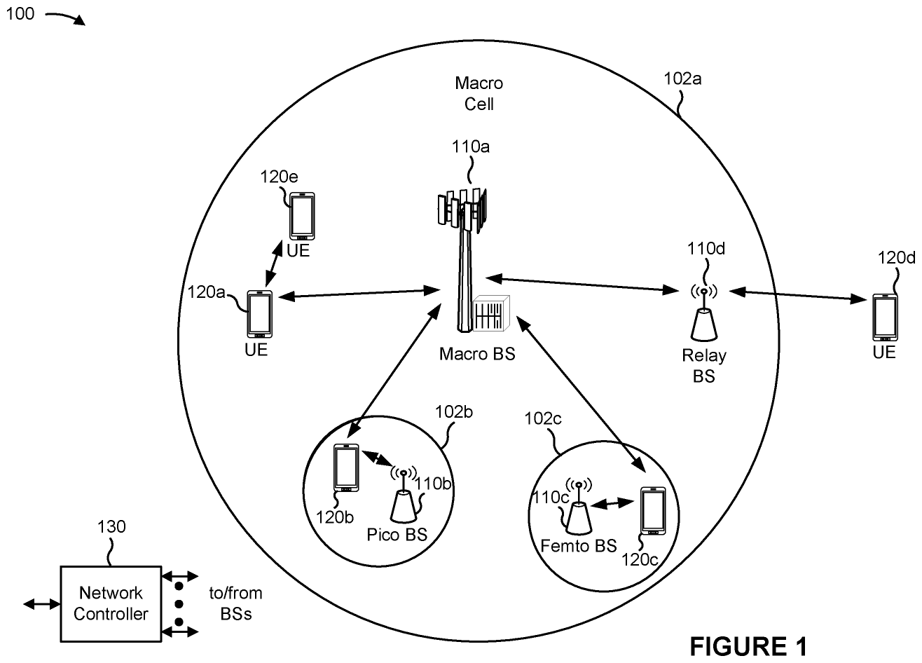

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

Abase station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands failing within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

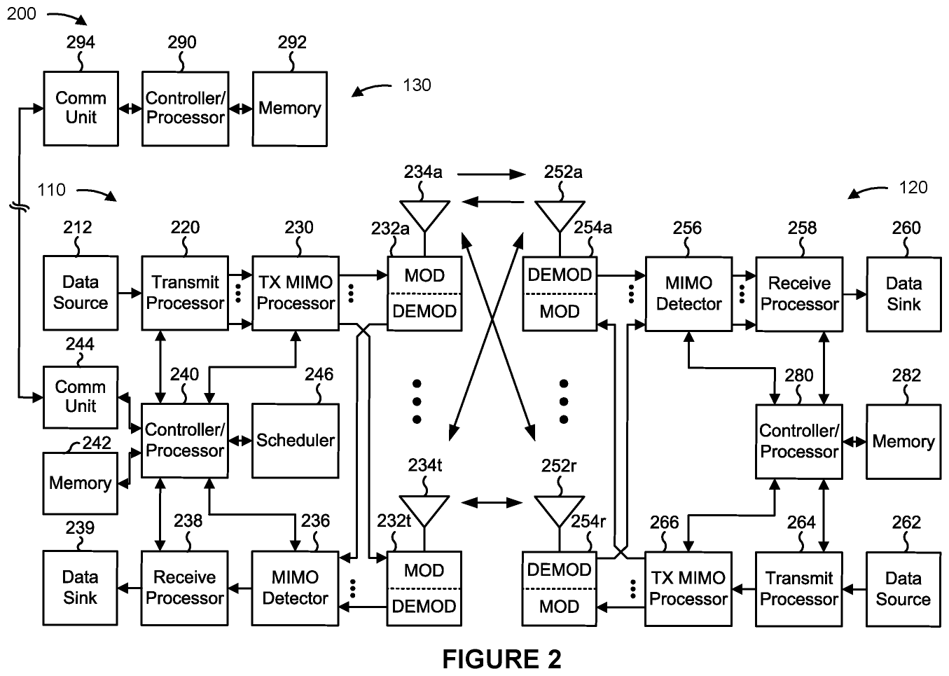

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

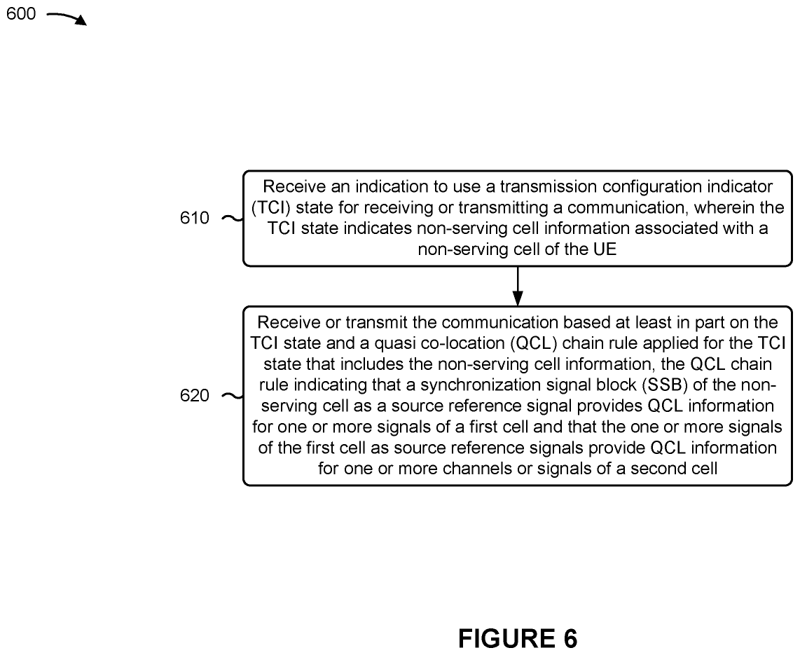

The controller/processor 240 of the base station 110, the controller/processor 280 of the UE 120, or any other component(s) of FIG. 2 may perform one or more techniques associated with a TCI indicator indication for non-serving cell information, as described in more detail elsewhere herein. For example, the controller/processor 240 of the base station 110, the controller/processor 280 of the UE 120, or any other component(s) of FIG. 2 may perform or direct operations of, for example, process 600 of FIG. 6, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of for example, process 600 of FIG. 6, or other processes as described herein. In some aspects, executing instructions may include running the instructions, converting the instructions, compiling the instructions, or interpreting the instructions, among other examples.

In some aspects, the UE 120 includes means for receiving an indication to use a TCI state for receiving or transmitting a communication, where the TCI state indicates non-serving cell information associated with a non-serving cell of the UE 120; or means for receiving or transmitting the communication based at least in part on the TCI state and a QCL chain rule applied for the TCI state that indicates the non-serving cell information, the QCL chain rule indicating that an SSB of the non-serving cell, as a source reference signal of a TCI state, provides QCL information for one or more signals of a first cell and that the one or more signals of the first cell, as a source reference signal of a TCI state, provide QCL information for one or more channels or signals of a second cell. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE 120 includes means for receiving a configuration for one or more channels or signals associated with the non-serving cell; or means for receiving or transmitting the communication further based at least in part on the configuration for the one or more channels or signals associated with the non-serving cell of the UE.

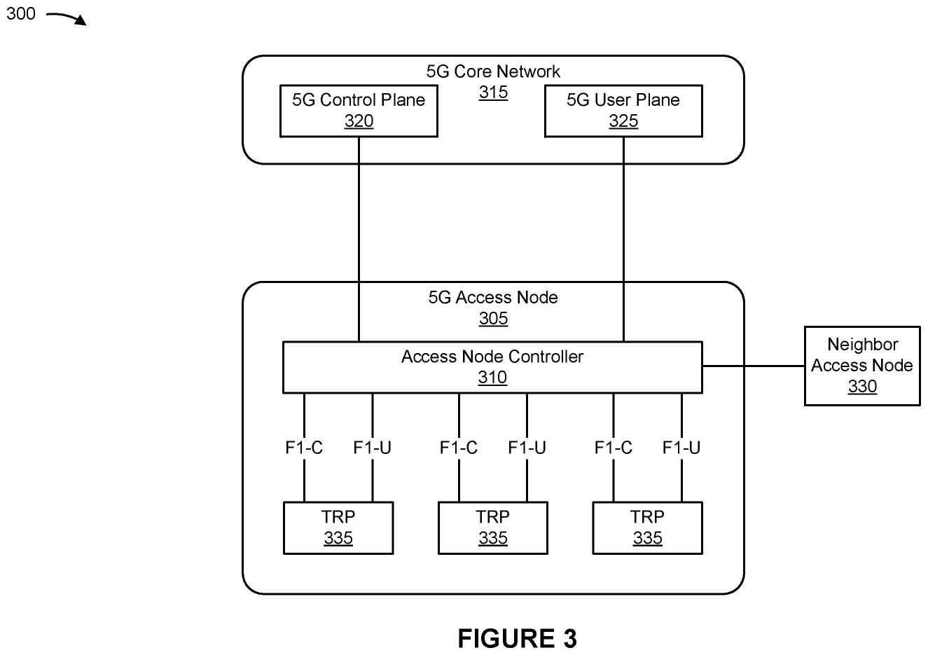

FIG. 3 illustrates an example logical architecture of a distributed RAN 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (for example, a 5G gateway), and the backhaul interface for one or both of the 5G control plane and the 5G user plane may terminate at the access node controller 310. Additionally or alternatively, a backhaul interface to one or more neighbor access nodes 330 (for example, another 5G access node 305 or an LTE access node) may terminate at the access node controller 310.

The access node controller 310 may include or may communicate with one or more TRPs 335 (for example, via an F1 Control (F1-C) interface or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally or alternatively, multiple TRPs 335 may be included in a single base station 110. In some aspects, a base station 110 may include a CU (for example, access node controller 310) or one or more DUs (for example, one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, or a medium access control (MAC) layer may be configured to terminate at the access node controller 310 or at a TRP 335.

In some aspects, multiple TRPs 335 may transmit communications (for example, the same communication or different communications) in the same transmission time interval (TTI) (for example, a slot, a mini-slot, a subframe, or a symbol) or different TTIs using different QCL relationships (for example, different spatial parameters, different TCI states, different precoding parameters, or different beamforming parameters). The QCL types corresponding to each a reference signal may be given by the higher layer parameter qcl-Type in QCL-Info and may take one of the following values: 1) ‘QCL-TypeA’: (Doppler shift, Doppler spread, average delay, delay spread); 2)‘QCL-TypeB’: (Doppler shift, Doppler spread); 3) ‘QCL-TypeC’: (Doppler shift, average delay); 4) ‘CL-TypeD’: (Spatial reception parameter or spatial transmit parameter). In some aspects, a TCI state may be used to indicate one or more QCL relationships. In some aspects, a TCI state may be used to indicate a transmit spatial filter to one more uplink transmissions. A TRP 335 may be configured to individually (for example, using dynamic selection) or jointly (for example, using joint transmission with one or more other TRPs 335) serve traffic to a UE 120.

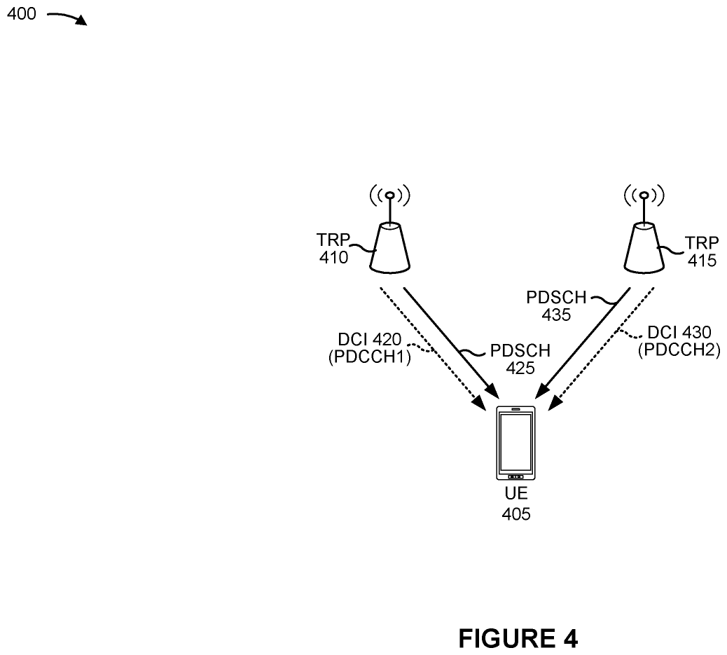

FIG. 4 is a diagram illustrating an example 400 of inter-cell multi-DCI based multi-TRP operation in accordance with the present disclosure. As shown, a UE 405 may communicate with a first TRP 410 and a second TRP 415. The UE 405 may be, or be similar to, the UE 120 shown in FIG. 1. The first TRP 410 or the second TRP 415 may be, or be similar to, the base station 110 shown in FIG. 1. In some aspects, the UE 405 may communicate with any quantity of additional TRPs not shown.

The UE 405 may be configured with multi-DCI based multi-TRP operation. As shown, when configured with multi-DCI based multi-TRP operation, the UE 405 may receive, from the first TRP 410, a first DCI transmission 420 in a first physical downlink control channel (PDCCH) transmission (shown as “PDCCH1”), where the first DCI transmission 420 may schedule a first physical downlink shared channel (PDSCH) transmission 425 to be transmitted by the first TRP 410. Similarly, the UE 405 may receive, from the second TRP 415, a second DCI transmission 430 in a second PDCCH (shown as “PDCCH2”), where the second DCI transmission 430 may schedule a second PDSCH transmission 435 to be transmitted by the second TRP 415. In association with monitoring DCIs transmitted from the first TRP 410 and the second TRP 415, the UE 405 may monitor PDCCH candidates in PDCCH monitoring occasions in a quantity of different core resource sets (CORESETs), as configured by the network. Although PDSCH is provided as the example here, other channels or signals such as PUSCH, PUCCH, SRS or CSI-RS may also be scheduled by the first DCI transmission 420 or the second DCI transmission 430.

In some cases, the first TRP 410 may be associated with a serving cell of the UE 405. For example, the first TRP 410 may be a base station that provides the serving cell or a relay device that provides access to the serving cell. In some cases, a quantity of additional TRPs may be associated with a quantity of additional serving cells. In some cases, the second TRP 415 may be associated with a non-serving cell. To communicate with a cell and receive a DCI transmission, the UE 405 may acquire beam indications for beam selection based on a TCI state. In some cases, SSB information may be used to perform channel measurement, obtain TCI state, or select beams for communication. The UE 405 may obtain SSB transmission position, SSB transmission periodicity, and SSB transmission power associated with the cell and use that information to facilitate receiving and decoding a DCI transmission.

As described above, a UE 405 utilizing inter-cell multi-TRP can be connected to multiple TRPs for joint scheduling and transmission/reception of communications. For example, a UE 405 may be connected to a first TRP 410 and a second TRP 415 such that the UE 405 can be jointly scheduled for transmission/reception of communications with the first TRP 410 or the second TRP 415. The first TRP 410 may provide a serving cell of the UE, and the second TRP 415 may provide a non-serving cell of the UE, where the serving cell and the non-serving cell are associated with different cell identifiers (for example, physical cell identifiers (PCIs)).

In some deployments, to support inter-cell multi-TRP, a UE 405 may be configured with information related to the non-serving cell (herein referred to as non-serving cell information). This non-serving cell information may include the cell identifier of the non-serving cell (for example, a PCI) or information associated with an SSB of the non-serving cell (for example, an SSB time domain position, an SSB transmission periodicity, or an SSB transmission power), among other examples. In practice, the UE 405 is configured with (at least) the cell identifier of the non-serving cell and the information associated with the SSB of the non-serving cell to enable inter-cell multi-TRP operation.

Additionally, a source reference signal in a TCI state provides QCL information for receiving or transmitting a target reference signal or channel. That is, a TCI state defines a QCL relationship between a source reference signal and a target reference signal or channel. The source reference signal in a TCI state can be, for example, an SSB, a channel state information reference signal (CSI-RS), sounding reference signal (SRS), or a tracking reference signal (TRS). The target reference signal or channel can be, for example, a TRS, a CSI-RS, a demodulation reference signal (DMRS) of a physical downlink control channel (PDCCH), a PDCCH, a DMRS of a physical downlink shared channel (PDSCH), a PDSCH, a DMRS of a physical uplink control channel (PUCCH), a PUCCH, a DMRS of a physical uplink shared channel (PUSCH), a PUSCH, or a sounding reference signal (SRS), among other examples. As a particular example, one TCI state may provide QCL information using an SSB as the source reference signal to a CSI-RS, while another TCI state may provide QCL information using the CSI-RS as the source reference signal to a DMRS of a PDCCH or a PDSCH. Conventionally, a TCI state is associated with the serving cell of the UE. That is, the TCI state conventionally provides QCL information using a source reference signal associated with the serving cell to a target reference signal or channel of the serving cell.

However, to support inter-cell multi-TRP, a reference signal from the non-serving cell can be indicated in a TCI state. For example, the TCI state may provide QCL information using a source reference signal associated with the non-serving cell to a target reference signal or channel of the serving cell or the non-serving cell. The source reference signal associated with the non-serving cell may be, for example, the SSB associated with the non-serving cell. In this scenario, the TCI state may indicate the non-serving cell information, such as the cell identifier of the non-serving cell. However, a rule defining a QCL chain from a source reference signal to a target reference signal needs to be defined to enable a TCI indication indicating non-serving cell information to be used to support inter-cell multi-TRP.

Various aspects relate generally to a quasi co-location (QCL) chain rule to be applied when a transmission configuration indicator (TCI) indication indicates information associated with a non-serving cell. Some aspects more specifically relate to a QCL chain rule to be applied when a TCI state that indicates non-serving cell information is indicated to a user equipment (UE) for use in association with transmitting or receiving a communication (for example, a communication with a serving cell of the UE, a communication with the non-serving cell of the UE). In some aspects, the QCL chain rule may be utilized by a UE configured for inter-cell multi-downlink control information (DCI) multi-TRP operation. A TCI state defines a QCL relationship between a source reference signal and a target reference signal. In some aspects, the QCL chain rule defines QCL relationships among a group of signals or channels. For example, the QCL chain rule may define that a synchronization signal block (SSB) of the non-serving cell, as a source reference signal, provides QCL information for one or more signals of a first cell, the first cell being the serving cell or the non-serving cell. In some aspects, the QCL chain rule further indicates that the one or more signals of the first cell, as the source signal, provide QCL information for one or more channels or signals of a second cell, the second cell being the serving cell or the non-serving cell. That is, the QCL chain rule may indicate a QCL relationship between an SSB of the non-serving cell and one or more signals of the first cell, and may further indicate a QCL relationship between the one or more signals of the first cell and one or more channels or signals of the second cell. In some aspects, the UE implements the QCL chain rule to determine a configuration for a beam to be used in association with transmitting or receiving a communication. That is, the UE may utilize the QCL chain rule to determine a beam indication according to the QCL relationships associated with the QCL chain rule, and may transmit or receive a communication accordingly. Further, some aspects more specifically relate to configuration for one or more channels or signals associated with the non-serving cell.

In some aspects, when a target reference signal which is configured in a serving cell is indicated with a TCI state of a source reference signal from another non-serving cell, there are two options to treat with the target reference. In the first option, a target reference signal which is configured in a serving cell is indicated with a first TCI state of a source reference signal from another non-serving cell may be treated as a non-serving cell reference signal, and if a second TCI state further includes the target reference signal as a source reference signal, the second TCI may be regard as a TCI state with non-serving cell information. In the second option, a target reference signal which is configured in a serving cell is indicated with a first TCI state of a source reference signal from another non-serving cell may be treated as a serving cell reference signal, and if a second TCI state further includes the target reference signal as a source reference signal, the second TCI may be regard as a TCI state with serving cell information.

Particular aspects of the subject matter described in this disclosure can be implemented to realize one or more of the following potential advantages. In some examples, the described techniques can enable inter-cell multi-TRP operation using a TCI state that indicates non-serving cell information without significantly increasing complexity of the UE. As an example, the described techniques can enable a UE to utilize non-serving cell information, indicated in a TCI state signaled to the UE, to determine a configuration for a beam to be used in association with transmitting or receiving a communication during inter-cell multi-TRP operation in a simplified manner (for example, based on the non-serving cell information and the QCL rule) and without a need for explicit configuration of the beam, thereby reducing complexity of inter-cell multi-TRP operation at the UE. Additionally, in some examples, the described techniques can be used to enable a beam of the non-serving cell to be used for transmitting or receiving a communication during inter-cell multi-TRP operation, thereby improving reliability of communications during inter-cell multi-TRP operation. As an example, the described techniques can enable a UE to determine, based on the non-serving cell information and the QCL rule, a configuration for a beam of the non-serving cell to enable the beam of the non-serving cell to be used in association with transmitting or receiving a communication, meaning that reliability of communications during inter-cell multi-TRP operation can be improved (for example, by enabling the beam of the non-serving cell to be used for the communication). As a result, some aspects of the subject matter described in this disclosure may have a positive impact on network performance or device performance.

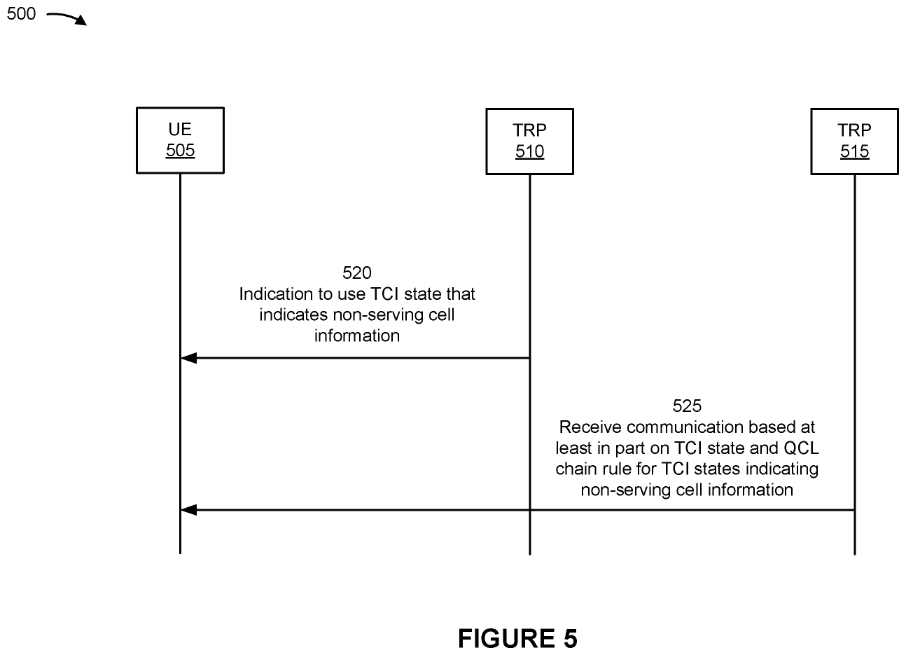

FIG. 5 is a diagram illustrating an example 500 associated with a TCI indication for non-serving cell information, in accordance with the present disclosure. As shown, a UE 505 may be connected to a first TRP 510 and a second TRP 515. In some aspects, the UE 505 may be similar to the UE 405 shown in FIG. 4. In some aspects, the TRP 510 or TRP 515 may be similar to the TRP 410 or the TRP 415 shown in FIG. 4. In example 500, the TRP 510 is associated with a serving cell of the UE 505 and the TRP 515 is associated with a non-serving cell of the UE 505.

In a first operation 520, the UE 505 receives an indication to use a TCI state for receiving or transmitting a communication, where the indicated TCI state indicates non-serving cell information associated with the non-serving cell of the UE 505 (for example, the non-serving cell supported by the TRP 515). In some aspects, the non-serving cell information may include, for example, a cell identifier (for example, a PCI) associated with the non-serving cell, SSB information associated with the non-serving cell, a CSI-RS or SRS associated with the non-serving cell (for example, when the CSI-RS or the SRS associated with the non-serving cell is pre-configured in the manner described below). Here, the indication indicates that the UE 505 is to use the TCI state with the non-serving cell information (for example, a beam associated with the non-serving cell) to receive the communication (in the case of the communication being a downlink communication) or transmit the communication (in the case of the communication being an uplink communication) via one or more channels or signals. In some aspects, the UE 505 receives the indication from the TRP 510 associated with the serving cell, as shown in FIG. 5.

In a second operation 525, the UE 505 receives or transmits the communication based at least in part on the TCI state and a QCL chain rule applied for the TCI state that indicates the non-serving cell information. Notably, while a particular example in which the UE 505 receives a communication from the serving cell is shown in FIG. 5, other examples are possible. For example, the UE 505 may receive a communication from the non-serving cell, the UE 505 may transmit a communication to the serving cell, or the UE 505 may transmit a communication to the non-serving cell.

In some aspects, the QCL chain rule defines that an SSB of the non-serving cell, as a source reference signal of a TCI state, provides QCL information for one or more signals of a first cell, and that the one or more signals of the first cell as source reference signals in TCI states provide QCL information for one or more channels or signals of a second cell. In some aspects, the one or more signals of the first cell (for example, the serving cell or the non-serving cell) include at least one of a CSI-RS, a TRS, or an SRS. In some aspects, the one or more channels or signals of the second cell include at least one of a PDCCH, a DMRS of the PDCCH, a PDSCH, a DMRS of the PDSCH, a physical uplink control channel (PUCCH), a DMRS of the PUCCH, a physical uplink shared channel (PUSCH), a DMRS of the PUSCH, or an SRS.

In some examples, the first cell associated with the QCL chain rule is the non-serving cell and the second cell associated with the QCL chain rule is also the non-serving cell. That is, in some aspects, the QCL chain rule indicates that an SSB of the non-serving cell, as a source reference signal of a TCI state, provides QCL information for one or more signals of the non-serving cell, and that the one or more signals of the non-serving cell as source reference signals in TCI states provide QCL information for one or more other channels or signals of the non-serving cell. As a particular example, the QCL chain rule may indicate that the SSB of the non-serving cell, as a source reference signal of a TCI state, can provide QCL information (for example, QCL-Type C information or QCL-Type D information) to a CSI-RS or a TRS of the non-serving cell, and that the CSI-RS or the TRS of the non-serving cell as source reference signals in TCI states can provide QCL information (for example, QCL-Type A information or QCL-Type D information) to a DMRS of a PDCCH or PDSCH configured in the non-serving cell. As a further particular example, the QCL chain rule may indicate that the SSB of the non-serving cell, as a source reference signal of a TCI state, can provide QCL information (for example, QCL-Type C information or QCL-Type D information) to a DMRS of a PDCCH, PUCCH, PUSCH or PDSCH configured in the non-serving cell.

In some other examples, the first cell associated with the QCL chain rule is the serving cell, and the second cell associated with the QCL chain rule is the serving cell. That is, in some aspects, the QCL chain rule indicates that an SSB of the non-serving cell, as a source reference signal of a TCI state, provides QCL information for one or more signals of the serving cell, and that the one or more signals of the serving cell as source reference signals in TCI states provide QCL information for one or more other channels or signals of the serving cell. As a particular example, the QCL chain rule may indicate that the SSB of the non-serving cli, as a source reference signal of a TCI state, can provide QCL information (for example, QCL-Type C information or QCL-Type D information) to a CSI-RS or a TRS of the serving cell, and that the CSI-RS or the TRS of the serving cell as source reference signal in TCI states can provide QCL information (for example, QCL-Type A information or QCL-Type D information) to a DMRS of a PDCCH or PDSCH configured in the serving cell. As a further particular example, the QCL chain rule may indicate that the SSB of the non-serving cell, as a source reference signal of a TCI state, can provide QCL information (for example, QCL-Type C information or QCL-Type D information) to a DMRS of a PDCCH, PUCCH, PUSCH or PDSCH configured in the serving cell.

In some other examples, the first cell associated with the QCL chain rule is the non-serving cell, and the second cell associated with the QCL chain rule is the serving cell. That is, in some aspects, the QCL chain rule indicates that an SSB of the non-serving cell, as a source reference signal of a TCI state, provides QCL information for one or more signals of the non-serving cell, and that the one or more signals of the non-serving cell as source reference signals in TCI states provide QCL information for one or more channels or signals of the serving cell. As a particular example, the QCL chain rule may indicate that the SSB of the non-serving cell, as a source reference signal of a TCI state, can provide QCL information (for example, QCL-Type C information or QCL-Type D information) to a CSI-RS or a TRS of the non-serving cell, and that the CSI-RS or the TRS of the non-serving cell as source reference signals in TCI states can provide QCL information (for example, QCL-Type A information or QCL-Type D information) to a DMRS of a PDCCH or PDSCH configured in the serving cell. As a further particular example, the QCL chain rule may indicate that the SSB of the non-serving cli, as a source reference signal of a TCI state, provides QCL information (for example, QCL-Type C information or QCL-Type D information) to a DMRS of a PDCCH, PUCCH, PUSCH or PDSCH configured in the serving cell.

In some aspects, the one or more channels or signals associated with receiving or transmitting the communication may be associated with the serving cell of the UE 505 (for example, the serving cell supported by the TRP 510), as described above. Here, the UE 505 may use the indicated TCI state (for example, the beam associated with the non-serving cell) to receive/transmit the one or more channels or signals from/to the serving cells according to the QCL chain rule. Alternatively, in some aspects, the one or more channels or signals may be associated with the non-serving cell of the UE 505 (for example, the non-serving cell supported by the TRP 515). In such a case, the one or more channels or signals are preconfigured channels or signals for the non-serving cell of the UE 505 in the manner described below. Thus, the UE 505 may use the indicated TCI state (for example, the beam associated with the non-serving cell) to receive/transmit the one or more channels or signals from/to the non-serving cell according to the QCL chain rule. In this way, the UE 505 is enabled for inter-cell multi-TRP involving a non-serving cell of the UE 505. For example, the UE 505 can apply a beam from the non-serving cell to transmit or receive one or more channels or signals from the serving cell or from the non-serving cell.

In some aspects, the UE 505 applies the QCL chain rule and determines a configuration for a beam to be used in association with transmitting or receiving the communication. For example, the QCL chain rule may indicate that the SSB of the non-serving ccli, as a source reference signal of a TCI state, provides QCL information for a signal (for example, a CSI-RS or a TRS or an SRS) associated with the first cell, and may indicate that the signal associated with the first cell provides QCL information for a signal associated with a channel in which the communication is to be transmitted or received (for example, a DMRS of a PUCCH, a DMRS of a PDSCH, a DMRS of a PUCCH, a DMRS of a PUSCH, or an SRS). Here, the UE 505 may determine the beam to be used for transmitting or receiving the communication according to the QCL chain rule (for example, based at least in part on the QCL relationship between the SSB and the signal associated with the first cell and the QCL relationship between the signal associated with the first cell and the signal associated with the second cell).

In some implementations, when the first cell or the second cell associated with the QCL chain rule is the non-serving cell, the UE 505 may be preconfigured with a configuration for one or more channels or signals associated with the non-serving cell. In some aspects, such configuration is needed because the UE 505 would not otherwise have a configuration for the one or more channels or signals associated with the non-serving cell and, therefore, would be unable to apply the QCL chain rule in association with transmitting/receiving the communication. Thus, in some aspects, the UE 505 may receive a configuration for one or more channels or signals associated with the non-serving cell, and may receive or transmit the communication further based at least in part on the configuration for the one or more channels or signals associated with the non-serving cell. In some aspects, the UE 505 may receive the configuration for the one or more channels or signals associated with the non-serving cell prior to or concurrent with receiving the indication to use the TCI state that indicates the non-serving cell information (for example, the UE 505 may receive the configuration prior to the first operation 520).

In some aspects, the configuration for one or more channels or signals associated with the non-serving cell includes a CSI-RS configuration associated with the non-serving cell. In some aspects, the configured CSI-RS, may be periodic, semi-persistent, or aperiodic. In some aspects, the configured CSI-RS may be used in association with tracking, CSI acquisition, beam management, or UE mobility, among other examples. In some aspects, the CSI-RS configuration indicates a set of radio resource control (RRC) parameters for a non-zero power (NZP) CSI-RS resource. In some aspects, the set of RRC parameters for the CSI-RS may include an RRC configured CSI-RS configuration, a CSI-RS set configuration (for example, a CSI-RS periodicity or a CSI-RS resource allocation, among other examples), or one or more power offset related parameters, among other examples. For example, the CSI-RS configuration associated with the non-serving cell may be configured with a RRC signaling such as “CSI-ResourceConfig”.

In some aspects, configuration for the one or more channels or signals associated with the non-serving cell includes an SRS configuration associated with the non-serving cell. In some aspects, the configured SRS, may be periodic, semi-persistent, or aperiodic. In some aspects, the configured SRS may be used in association with a beam management or antenna switching, among other examples. In some aspects, a set usage of the configured SRS may be set as codebook or non-codebook. In some aspects, the SRS configuration indicates a set of RRC parameters for an SRS resource. In some aspects, the set of RRC parameters for the SRS resource may include an RRC configured SRS configuration, an SRS set configuration (for example, an SRS periodicity or an SRS resource allocation), a target power, a pathloss compensation factor, a closed-loop index, or a pathloss reference signal, among other examples. For example, the SRS configuration associated with the non-serving cell may be configured with a RRC signaling such as “SRS-Config.”

In some aspects, configuration for the one or more channels or signals associated with the non-serving cell includes a PDCCH configuration associated with the non-serving cell. In some aspects, the PDCCH configuration indicates a set of RRC parameters for PDCCH reception. In some aspects, the set of RRC parameters for PDCCH reception includes at least one of an RRC configured CORESET configuration or a search space set configuration. For example, the PDCCH configuration associated with the non-serving cell may be configured with a RRC signaling such as “PDCCH-Config.”

In some aspects, configuration for the one or more channels or signals associated with the non-serving cell includes a PDSCH configuration associated with the non-serving cell. In some aspects, the PDSCH configuration indicates a set of RRC parameters for PDSCH reception. In some aspects, the set of RRC parameters for PDSCH reception includes an RRC configured PDSCH configuration. For example, the PDSCH configuration associated with the non-serving cell may be configured with a RRC signaling such as “PDSCH-Config.”

In some aspects, configuration for the one or more channels or signals associated with the non-serving cell includes a PUCCH configuration associated with the non-serving cell. In some aspects, the PUCCH configuration indicates a set of RRC parameters for PUCCH transmission. In some aspects, the set of RRC parameters for PUCCH transmission includes an RRC configured PUCCH configuration. For example, the PUCCH configuration associated with the non-serving cell may be configured with a RRC signaling such as “PUCCH-Config.”

In some aspects, configuration for the one or more channels or signals associated with the non-serving cell includes a PUSCH configuration associated with the non-serving cell. In some aspects, the PUSCH configuration indicates a set of RRC parameters for PUSCH transmission. In some aspects, the set of RRC parameters for PUSCH transmission includes an RRC configured PUSCH configuration. For example, the PUCCH configuration associated with the non-serving cell may be configured with a RRC signaling such as “PUCCH-Config.”

In some aspects, if the target channels/signals are the ones configured for a serving cell, the UE needs to use the indicated TCI state to receive or transmit the target channels/signals based on configuration from the serving cell.

In some other aspects, when non-serving cell PCI is included in the TCI state, the TCI state may be indicated to the target channels/signals if and only of the QCL rule is supported to do so. The UE needs to use the indicated TCI state of non-serving cell information (for example, use a beam from non-serving cell) to receive or transmit target channels/signals from a serving or non-serving cell. If the target channels/signals are the ones configured for a serving cell, UE need to use the indicated TCI state to receive or transmit channels/signals from the serving cell. If the target channels/signals are the ones preconfigured for non-serving cells, UE need to use the indicated TCI state to receive or transmit target channels/signals from the non-serving cell. The TCI state may include non-serving cell PCI and include a SSB or if preconfigured, a CSI-RS or a SRS as the source reference signal.

FIG. 6 is a flowchart illustrating an example process 600 performed, for example, by a UE in accordance with the present disclosure. Example process 600 is an example where the UE (for example, UE 120, UE 405) performs operations associated with transmission configuration indicator indication for non-serving cell information.

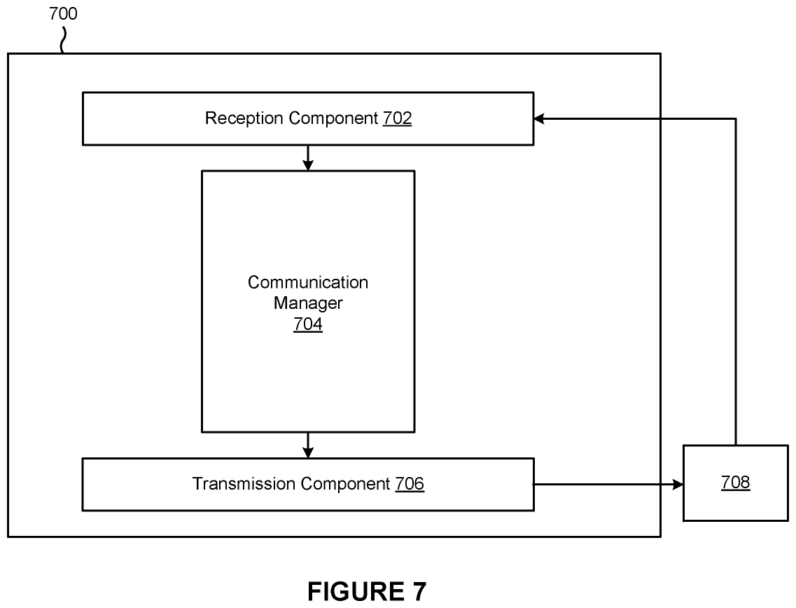

As shown in FIG. 6, in some aspects, process 600 may include receiving an indication to use a TCI state for receiving or transmitting a communication, wherein the TCI state indicates non-serving cell information associated with a non-serving cell of the UE (block 610). For example, the UE (such as by using reception component 702, depicted in FIG. 7) may receive an indication to use a TCI state for receiving or transmitting a communication, wherein the TCI state indicates non-serving cell information associated with a non-serving cell of the UE, as described above. In some aspects, the TCI state indicates non-serving cell information associated with a non-serving cell of the UE.

As further shown in FIG. 6, in some aspects, process 600 may include receiving or transmitting the communication based at least in part on the TCI state and a QCL chain rule applied for the TCI state that indicates the non-serving cell information, the QCL chain rule indicating that an SSB of the non-serving cell as a source reference signal (in a TCI state) provides QCL information for one or more signals of a first cell and that the one or more signals of the first cell as source reference signals (in TCI states) provide QCL information for one or more channels or signals of a second cell (block 620). For example, the UE (such as by using reception component 702 or transmission component 706, depicted in FIG. 7) may receive or transmit the communication based at least in part on the TCI state and a QCL chain rule applied for the TCI state that indicates the non-serving cell information, as described above. In some aspects, the QCL chain rule indicates that an SSB of the non-serving cell as a source reference signal provides QCL information for one or more signals of a first cell and that the one or more signals of the first cell as source reference signals provide QCL information for one or more channels or signals of a second cell, as described above.

Process 600 may include additional aspects, such as any single aspect or any combination of aspects described below or in connection with one or more other processes described elsewhere herein.

In a first additional aspect, the first cell is the non-serving cell of the UE and the second cell is the non-serving cell of the UE.

In a second additional aspect, alone or in combination with the first aspect, the first cell is a serving cell of the UE and the second cell is the serving cell of the UE.

In a third additional aspect, alone or in combination with one or more of the first and second aspects, the first cell is the non-serving cell of the UE and the second cell is a serving cell of the UE.

In a fourth additional aspect, alone or in combination with one or more of the first through third aspects, the one or more signals of the first cell include at least one of a CSI-RS or a TRS.

In a fifth additional aspect, alone or in combination with one or more of the first through fourth aspects, the one or more channels or signals of the second cell include at least one of a PDCCH, a DMRS of the PDCCH, a PDSCH, a DMRS of the PDSCH, a PUCCH, a DMRS of the PUCCH, a PUSCH, a DMRS of the PUSCH, or an SRS.

In a sixth additional aspect, alone or in combination with one or more of the first through fifth aspects, process 600 includes receiving a configuration for one or more channels or signals associated with the non-serving cell, wherein receiving or transmitting the communication further comprises receiving or transmitting the communication further based at least in part on the configuration for the one or more channels or signals associated with the non-serving cell of the UE.

In a seventh additional aspect, alone or in combination with one or more of the first through sixth aspects, the configuration includes a CSI-RS configuration associated with the non-serving cell, the CSI-RS configuration indicating a set of RRC parameters for a NZP CSI-RS resource.

In an eighth additional aspect, alone or in combination with one or more of the first through seventh aspects, the configuration includes an SRS configuration associated with the non-serving cell, the SRS configuration indicating a set of RRC parameters for an SRS resource.

In a ninth additional aspect, alone or in combination with one or more of the first through eighth aspects, the configuration includes a PDCCH configuration associated with the non-serving cell, the PDCCH configuration indicating a set of RRC parameters for PDCCH reception.

In a tenth additional aspect, alone or in combination with one or more of the first through ninth aspects, the configuration includes a PDSCH configuration associated with the non-serving cell, the PDSCH configuration indicating a set of RRC parameters for PDSCH reception.

In an eleventh additional aspect, alone or in combination with one or more of the first through tenth aspects, the configuration includes a PUCCH configuration associated with the non-serving cell, the PUCCH configuration indicating a set of RRC parameters for PUCCH transmission.

In a twelfth additional aspect, alone or in combination with one or more of the first through eleventh aspects, the configuration includes a PUSCH configuration associated with the non-serving cell, the PUSCH configuration indicating a set of RRC parameters for PUSCH transmission.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a block diagram of an example apparatus 700 for wireless communication in accordance with the present disclosure. The apparatus 700 may be a UE, or a UE may include the apparatus 700. In some aspects, the apparatus 700 includes a reception component 702, a communication manager 704, and a transmission component 706, which may be in communication with one another (for example, via one or more buses). As shown, the apparatus 700 may communicate with another apparatus 708 (such as a UE, a base station, or another wireless communication device) using the reception component 702 and the transmission component 706.

In some aspects, the apparatus 700 may be configured to perform one or more operations described herein in connection with FIG. 5. Additionally or alternatively, the apparatus 700 may be configured to perform one or more processes described herein, such as process 600 of FIG. 6. In some aspects, the apparatus 700 may include one or more components of the UE described above in connection with FIG. 2.

The reception component 702 may receive communications, such as reference signals, control information, data communications, or a combination thereof, from the apparatus 708. The reception component 702 may provide received communications to one or more other components of the apparatus 700, such as the communication manager 704. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a demodulator, a MIMO detector, a receive processor, a controller/processor, a memory, or a combination thereof, of the UE described above in connection with FIG. 2.

The transmission component 706 may transmit communications, such as reference signals, control information, data communications, or a combination thereof, to the apparatus 708. In some aspects, the communication manager 704 may generate communications and may transmit the generated communications to the transmission component 706 for transmission to the apparatus 708. In some aspects, the transmission component 706 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 706 may include one or more antennas, a modulator, a transmit MIMO processor, a transmit processor, a controller/processor, a memory, or a combination thereof, of the UE described above in connection with FIG. 2. In some aspects, the transmission component 706 may be co-located with the reception component 702 in a transceiver.

The communication manager 704 may receive or may cause the reception component 702 to receive an indication to use a TCI state for receiving or transmitting a communication, where the TCI state indicates non-serving cell information associated with a non-serving cell of a UE (for example, the apparatus 700). The communication manager 704 may receive or may cause the reception component 702 to receive or may transmit or may cause the transmission component 706 to transmit the communication based at least in part on the TCI state and a QCL chain rule applied for the TCI state that indicates the non-serving cell information. In some aspects, the QCL chain rule indicates that an SSB of the non-serving cell, as a source reference signal of a TCI state, provides QCL information for one or more signals of a first cell and that the one or more signals of the first cell as source reference signals in TCI states provide QCL information for one or more channels or signals of a second cell. In some aspects, the communication manager 704 may perform one or more operations described elsewhere herein as being performed by one or more components of the communication manager 704.

The communication manager 704 may include a controller/processor, a memory, or a combination thereof, of the UE described above in connection with FIG. 2. In some aspects, the communication manager 704 includes a set of components. Alternatively, the set of components may be separate and distinct from the communication manager 704. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive an indication to use a TCI state for receiving or transmitting a communication wherein the TCI state indicates non-serving cell information associated with a non-serving cell of the UE. The reception component 702 may receive or the transmission component 706 may transmit the communication based at least in part on the TCI state and a QCL chain rule applied for the TCI state that indicates the non-serving cell information. The QCL chain rule may indicate that an SSB of the non-serving cell as a source reference signal provides QCL information for one or more signals of a first cell and that the one or more signals of the first cell as source reference signals provide QCL information for one or more channels or signals of a second cell. In some aspects, the reception component 702 may receive a configuration for one or more channels or signals associated with the non-serving cell.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a UE, comprising: receiving an indication to use a TCI state for receiving or transmitting a communication, wherein the TCI state indicates non-serving cell information associated with a non-serving cell of the UE; and receiving or transmitting the communication based at least in part on the TCI state and a QCL chain rule applied for the TCI state that indicates the non-serving cell information, the QCL chain rule indicating that an SSB of the non-serving cell as a source reference signal provides QCL information for one or more signals of a first cell and that the one or more signals of the first cell as source reference signals provide QCL information for one or more channels or signals of a second cell.

Aspect 2: The method of Aspect 1, wherein the first cell is the non-serving cell of the UE and the second cell is the non-serving cell of the UE.

Aspect 3: The method of Aspect 1, wherein the first cell is a serving cell of the UE and the second cell is the serving cell of the UE.

Aspect 4: The method of Aspect 1, wherein the first cell is the non-serving cell of the UE and the second cell is a serving cell of the UE.

Aspect 5: The method of any of Aspects 1-4, wherein the one or more signals of the first cell include at least one of a channel state information reference signal (CSI-RS) or a tracking reference signal (TRS).

Aspect 6: The method of any of Aspects 1-5, wherein the one or more channels or signals of the second cell include at least one of a PDCCH, a DMRS of the PDCCH, a PDSCH, a DMRS of the PDSCH, a PUCCH, a DMRS of the PUCCH, a PUSCH, a DMRS of the PUSCH, or an SRS.

Aspect 7: The method of any of Aspects 1-6, further comprising: receiving a configuration for one or more channels or signals associated with the non-serving cell; and wherein receiving or transmitting the communication further comprises receiving or transmitting the communication further based at least in part on the configuration for the one or more channels or signals associated with the non-serving cell of the UE.

Aspect 8: The method of Aspect 7, wherein the configuration includes a channel state CSI-RS configuration associated with the non-serving cell, the CSI-RS configuration indicating a set of RRC parameters for a NZP CSI-RS resource.

Aspect 9: The method of any of Aspects 7-8, wherein the configuration includes an SRS configuration associated with the non-serving cell, the SRS configuration indicating a set of RRC parameters for an SRS resource.

Aspect 10: The method of any of Aspects 7-9, wherein the configuration includes a PDCCH configuration associated with the non-serving cell, the PDCCH configuration indicating a set of RRC parameters for PDCCH reception.

Aspect 11: The method of any of Aspects 7-10, wherein the configuration includes a PDSCH configuration associated with the non-serving cell, the PDSCH configuration indicating a set of RRC parameters for PDSCH reception.

Aspect 12: The method of any of Aspects 7-11, wherein the configuration includes a PUCCH configuration associated with the non-serving cell, the PUCCH configuration indicating a set of RRC parameters for PUCCH transmission.

Aspect 13: The method of any of Aspects 7-12, wherein the configuration includes a PUSCH configuration associated with the non-serving cell, the PUSCH configuration indicating a set of RRC parameters for PUSCH transmission.

Aspect 14: An apparatus for wireless communication at a device, comprising a processor, memory coupled with the processor, and instructions stored in the memory and executable by the processor to cause the apparatus to perform the method of one or more Aspects of Aspects 1-13.

Aspect 15: A device for wireless communication, comprising a memory and one or more processors coupled to the memory, the memory and the one or more processors configured to perform the method of one or more Aspects of Aspects 1-13.

Aspect 16: An apparatus for wireless communication, comprising at least one means for performing the method of one or more Aspects of Aspects 1-13.

Aspect 17: A non-transitory computer-readable medium storing code for wireless communication, the code comprising instructions executable by a processor to perform the method of one or more Aspects of Aspects 1-13.

Aspect 18: A non-transitory computer-readable medium storing a set of instructions for wireless communication, the set of instructions comprising one or more instructions that, when executed by one or more processors of a device, cause the device to perform the method of one or more Aspects of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, orany other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor, and
at least one memory communicatively coupled with the at least one processor and storing processor-readable code that, when executed by the at least one processor, is configured to cause the UE to:
receive an indication to use a transmission configuration indicator (TCI) state for receiving or transmitting a communication, wherein the TCI state indicates non-serving cell information associated with a non-serving cell of the UE; and
receive or transmit the communication based at least in part on the TCI state and a quasi co-location (QCL) chain rule applied for the TCI state that indicates the non-serving cell information, the QCL chain rule indicating that a synchronization signal block (SSB) of the non-serving cell as a source reference signal provides QCL information for one or more signals of a first cell and that the one or more signals of the first cell provide as source reference signals provide QCL information for one or more channels or signals of a second cell.

2. The UE of claim 1, wherein the first cell is a serving cell of the UE and the second cell is the serving cell of the UE.

3. The UE of claim 1, wherein the first cell is the non-serving cell of the UE and the second cell is the non-serving cell of the UE.

4. The UE of claim 1, wherein the first cell is the non-serving cell of the UE and the second cell is a serving cell of the UE.

5. The UE of claim 1, wherein the one or more signals of the first cell include at least one of a channel state information reference signal (CSI-RS) or a tracking reference signal (TRS).

6. The UE of claim 1, wherein the one or more channels or signals of the second cell include at least one of a physical downlink control channel (PDCCH), a demodulation reference signal (DMRS) of the PDCCH, a physical downlink shared channel (PDSCH), a DMRS of the PDSCH, a physical uplink control channel (PUCCH), a DMRS of the PUCCH, a physical uplink shared channel (PUSCH), a DMRS of the PUSCH, or a sounding reference signal (SRS).

7. The UE of claim 1, wherein the processor-readable code, when executed by the at least on processor, is further configured to cause the UE to:
receive a configuration for one or more channels or signals associated with the non-serving cell; and
wherein, to cause the UE to receive or transmit the communication, the processor-readable code, when executed by the at least one processor, is configured to cause the UE to receive or transmit the communication further based at least in part on the configuration for the one or more channels or signals associated with the non-serving cell of the UE.

8. The UE of claim 7, wherein the configuration includes a channel state information reference signal (CSI-RS) configuration associated with the non-serving cell, the CSI-RS configuration indicating a set of radio resource control (RRC) parameters for a non-zero power (NZP) CSI-RS resource.

9. The UE of claim 7, wherein the configuration includes a sounding reference signal (SRS) configuration associated with the non-serving cell, the SRS configuration indicating a set of radio resource control (RRC) parameters for an SRS resource.

10. The UE of claim 7, wherein the configuration includes a physical downlink control channel (PDCCH) configuration associated with the non-serving cell, the PDCCH configuration indicating a set of radio resource control (RRC) parameters for PDCCH reception.

11. The UE of claim 7, wherein the configuration includes a physical downlink shared channel (PDSCH) configuration associated with the non-serving cell, the PDSCH configuration indicating a set of radio resource control (RRC) parameters for PDSCH reception.

12. The UE of claim 7, wherein the configuration includes a physical uplink control channel (PUCCH) configuration associated with the non-serving cell, the PUCCH configuration indicating a set of radio resource control (RRC) parameters for PUCCH transmission.

13. The UE of claim 7, wherein the configuration includes a physical uplink shared channel (PUSCH) configuration associated with the non-serving cell, the PUSCH configuration indicating a set of radio resource control (RRC) parameters for PUSCH transmission.

14. A method of wireless communication performed by a user equipment (UE), comprising:
receiving an indication to use a transmission configuration indicator (TCI) state for receiving or transmitting a communication, wherein the TCI state indicates non-serving cell information associated with a non-serving cell of the UE; and
receiving or transmitting the communication based at least in part on the TCI state and a quasi co-location (QCL) chain rule applied for the TCI state that indicates the non-serving cell information,
the QCL chain rule indicating that a synchronization signal block (SSB) of the non-serving cell as a source reference signal provides QCL information for one or more signals of a first cell and that the one or more signals of the first cell as source reference signals provide QCL information for one or more channels or signals of a second cell.

15. The method of claim 14, wherein the first cell is a serving cell of the UE and the second cell is the serving cell of the UE.

16. The method of claim 14, wherein the first cell is the non-serving cell of the UE and the second cell is the non-serving cell of the UE.

17. The method of claim 14, wherein the first cell is the non-serving cell of the UE and the second cell is a serving cell of the UE.

18. The method of claim 14, wherein the one or more signals of the first cell include at least one of a channel state information reference signal (CSI-RS) or a tracking reference signal (TRS).

19. The method of claim 14, wherein the one or more channels or signals of the second cell include at least one of a physical downlink control channel (PDCCH), a demodulation reference signal (DMRS) of the PDCCH, a physical downlink shared channel (PDSCH), a DMRS of the PDSCH, a physical uplink control channel (PUCCH), a DMRS of the PUCCH, a physical uplink shared channel (PUSCH), a DMRS of the PUSCH, or a sounding reference signal (SRS).

20. The method of claim 14, further comprising:
receiving a configuration for one or more channels or signals associated with the non-serving cell; and
wherein receiving or transmitting the communication further comprises receiving or transmitting the communication further based at least in part on the configuration for the one or more channels or signals associated with the non-serving cell of the UE.

21. The method of claim 20, wherein the configuration includes a channel state information reference signal (CSI-RS) configuration associated with the non-serving cell, the CSI-RS configuration indicating a set of radio resource control (RRC) parameters for a non-zero power (NZP) CSI-RS resource.

22. The method of claim 20, wherein the configuration includes a sounding reference signal (SRS) configuration associated with the non-serving cll, the SRS configuration indicating a set of radio resource control (RRC) parameters for an SRS resource.

23. The method of claim 20, wherein the configuration includes a physical downlink control channel (PDCCH) configuration associated with the non-serving cell, the PDCCH configuration indicating a set of radio resource control (RRC) parameters for PDCCH reception.

24. The method of claim 20, wherein the configuration includes a physical downlink shared channel (PDSCH) configuration associated with the non-serving cell, the PDSCH configuration indicating a set of radio resource control (RRC) parameters for PDSCH reception.

25. The method of claim 20, wherein the configuration includes a physical uplink control channel (PUCCH) configuration associated with the non-serving cell, the PUCCH configuration indicating a set of radio resource control (RRC) parameters for PUCCH transmission.

26. The method of claim 20, wherein the configuration includes a physical uplink shared channel (PUSCH) configuration associated with the non-serving cell, the PUSCH configuration indicating a set of radio resource control (RRC) parameters for PUSCH transmission.

27. An apparatus for wireless communication, comprising:
means for receiving an indication to use a transmission configuration indicator (TCI) state for receiving or transmitting a communication, wherein the TCI state indicates non-serving cell information associated with a non-serving cell of the apparatus; and
means for receiving or transmitting the communication based at least in part on the TCI state and a quasi co-location (QCL) chain rule applied for the TCI state that indicates the non-serving cell information, the QCL chain rule indicating that a synchronization signal block (SSB) of the non-serving cell as a source reference signal provides QCL information for one or more signals of a first cell and that the one or more signals of the first cll as source reference signals provide QCL information for one or more channels or signals of a second cell.

28. The apparatus of claim 27, wherein the first cell is a serving cell of the apparatus and the second cell is the serving cell of the apparatus.

29. The apparatus of claim 27, wherein the first cell is the non-serving cell of the apparatus and the second cell is the non-serving cell of the apparatus.

30. The apparatus of claim 27, wherein the first cell is the non-serving cell of the apparatus and the second cell is a serving cell of the apparatus.
